(19) United States
(12) Patent Application Publication
(10) Pub. No.: US 2025/0093001 A1
(43) Pub. Date: Mar. 20, 2025

(54) Modular lighting apparatus

(71) Applicant: Sforzin Illuminazione di Sforzin Guido, Paderno Dugnano (MI) (IT)

(72) Inventor: Gerardo Antonio Mari, Milano (IT)

(21) Appl. No.: 18/444,950

(22) Filed: Feb. 19, 2024

(30) Foreign Application Priority Data
Feb. 20, 2023 (IT) 102023000002874

(51) Int. Cl. F21S 2/00; F21V 3/06; F21V 23/00; F21V 23/02; F21V 23/06; F21Y 115/10

(52) U.S. Cl. CPC F21S 2/005; F21V 3/0625; F21V 23/002; F21V 23/02; F21V 23/06; F21Y 2115/10

(57) ABSTRACT

A modular lighting apparatus includes a plurality of lighting modules and a plurality of connection bases. Each of the lighting modules has a shape elongated along a main longitudinal development direction and is configured to be connected, at its opposite longitudinal ends, to a pair of the connection bases. Each of the connection bases is configured to be connected to a plurality of the lighting modules.

### FIELD OF THE INVENTION

The present invention relates to a modular lighting apparatus that can be assembled as desired.

### BACKGROUND OF THE INVENTION

As it is well known, in the field of lighting engineering there is a need to create lighting systems capable of adapting, in shape and lighting performance, both to the specific characteristics of the environment in which they are inserted and to the aesthetic requirements of the end user or designer.

Today, there exist modular lighting apparatuses, i.e. lighting apparatuses comprising two or more lighting modules that can be joined together to obtain a lighting system having an overall shape and lighting performance given by the sum of the individual modules.

The modular lighting apparatuses of the known type, however, are not free from drawbacks, one of which is that they have very limited margins of freedom in the composition, and thus cannot allow the end user or the designer to achieve truly free shapes.

Another drawback of modular lighting apparatuses of the known type is that the composition and assembly thereof are often complex and burdensome, from the point of view of both the mechanical and the electrical connection of the various modules to each other, and therefore require a long time as well as the intervention of skilled personnel.

### SUMMARY OF THE INVENTION

In light of the above, the task of the present invention is to create a modular lighting apparatus that overcomes the limits of the prior art by allowing it to be composed as desired by the end user or designer, without significantly restricting the margins of freedom.

Within the scope of this task, an object of the present invention is to create a modular lighting apparatus that is simple to assemble and to connect, both mechanically and electrically.

An additional object of the invention consists in creating a modular lighting apparatus that is capable of giving the widest guarantees of reliability and safety in use.

Yet another object of the invention consists in creating a modular lighting apparatus that is easy to make and economically competitive if compared to the prior art.

The task set forth above, as well as the objects mentioned and others which will be more apparent hereinafter, are achieved by a modular lighting apparatus according to claim 1.

Other features are provided in the dependent claims.

### BRIEF DESCRIPTION OF THE DRAWINGS

Additional features and advantages of the present invention will become more apparent from the exemplary but non-limiting description of a preferred embodiment of the present invention illustrated with the aid of the attached drawings in which:

FIG. 1 is a perspective view of a part of a modular lighting apparatus according to the invention;

FIG. 2 shows the modular lighting apparatus of FIG. 1, in a non-assembled configuration;

FIG. 3 is a perspective view of the modular lighting apparatus of FIG. 1, in a non-assembled configuration;

FIG. 4 is an exploded perspective view of a connection base of the modular lighting apparatus according to the invention;

FIG. 5 represents the electrical circuit diagram of the connection base of FIG. 4;

FIG. 6 is an exploded perspective view of a lighting module of the modular lighting apparatus according to the invention;

FIG. 7 represents the electrical circuit diagram of the lighting module of FIG. 6;

FIG. 8 is a cross-section view of the lighting module of FIG. 6;

FIG. 9 schematically shows an operation that can be performed on the connection base for engaging a lighting module;

FIG. 10 is a plan view of part of the modular lighting apparatus according to the invention;

FIG. 11 is a perspective view of a possible linear configuration of the modular lighting apparatus, according to the invention, comprising four connection bases and three lighting modules;

FIG. 12 represents the electrical circuit diagram of the modular lighting apparatus of FIG. 11;

FIG. 13 is a perspective view of a possible grid configuration that the modular lighting apparatus according to the invention may have.

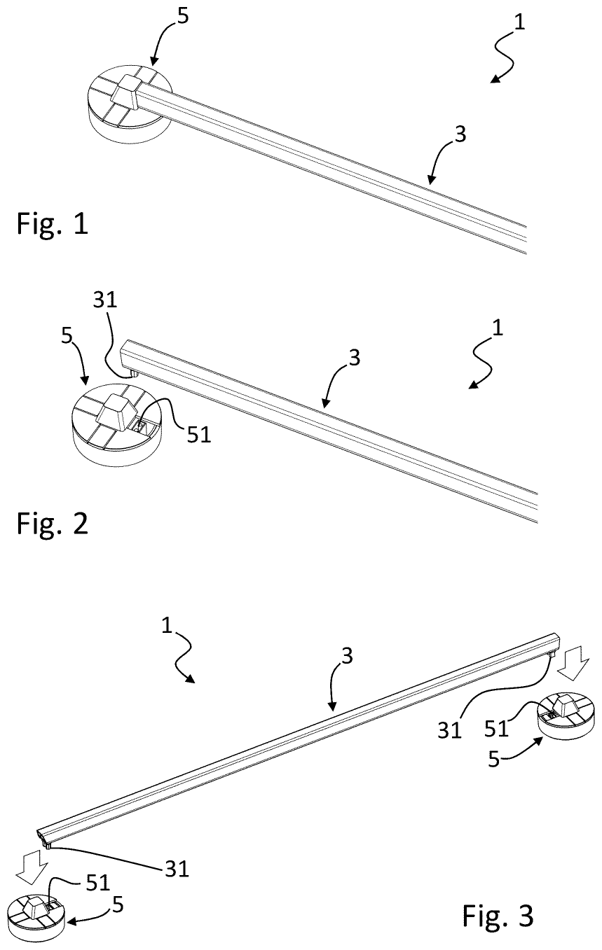

### DETAILED DESCRIPTION OF EMBODIMENTS OF THE INVENTION

With particular reference to the figures, the modular lighting apparatus is globally referred to by number 1.

According to the invention, the apparatus 1 comprises a plurality of lighting modules 3 and a plurality of connection bases 5 for these lighting modules 3.

Each of the lighting modules 3 has an elongated shape along one main development direction and is configured to be connected, at its opposite longitudinal ends, to a pair of these connection bases 5.

Each of the connection bases 5 is configured to be connected to a plurality of lighting modules 3.

Each lighting module 3 comprises:
one or more lighting sources 30;
a pair of first connectors 31 arranged at the longitudinal ends of said lighting module 3;
a pair of electrically conductive tracks 32 configured to transmit electric current between the first two connectors 31 and to the lighting source 30.

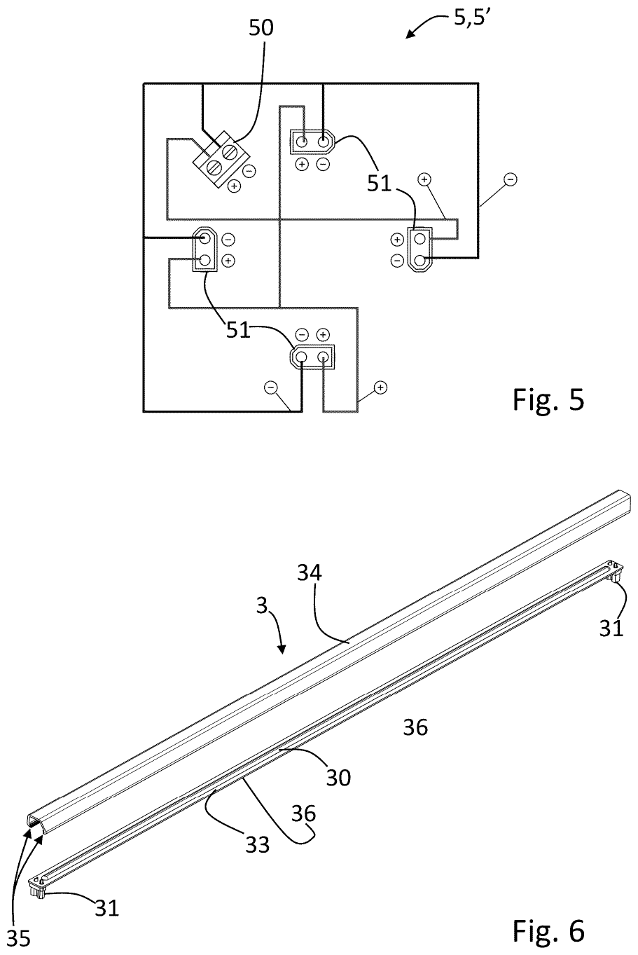

Each connection base 5 comprises a plurality of second connectors 51 mutually electrically connected to each other in parallel, as shown for example in FIG. 5.

Each of these second connectors 51 is adapted to be connected to a first connector 31 of a lighting module 3.

In addition, at least one main connection base 5′ of said plurality of connection bases 5 comprises a power supply terminal 50 electrically connected in parallel to the second connectors 51, adapted to be electrically connected to a power supply network.

Preferably, the lighting module 3 comprises a printed circuit 33 (PCB, from the English acronym “printed circuit board”) on which the two electrically conductive tracks 32 are obtained, and to which the first connectors 31 are associated.

Preferably, each lighting module 3 comprises a light diffuser 34 associated with the printed circuit 33 by means of a pair of sliding and support rails 35 configured to slide along the edges 36 of the printed circuit 33 and to support the diffuser 34 on the printed circuit 33.

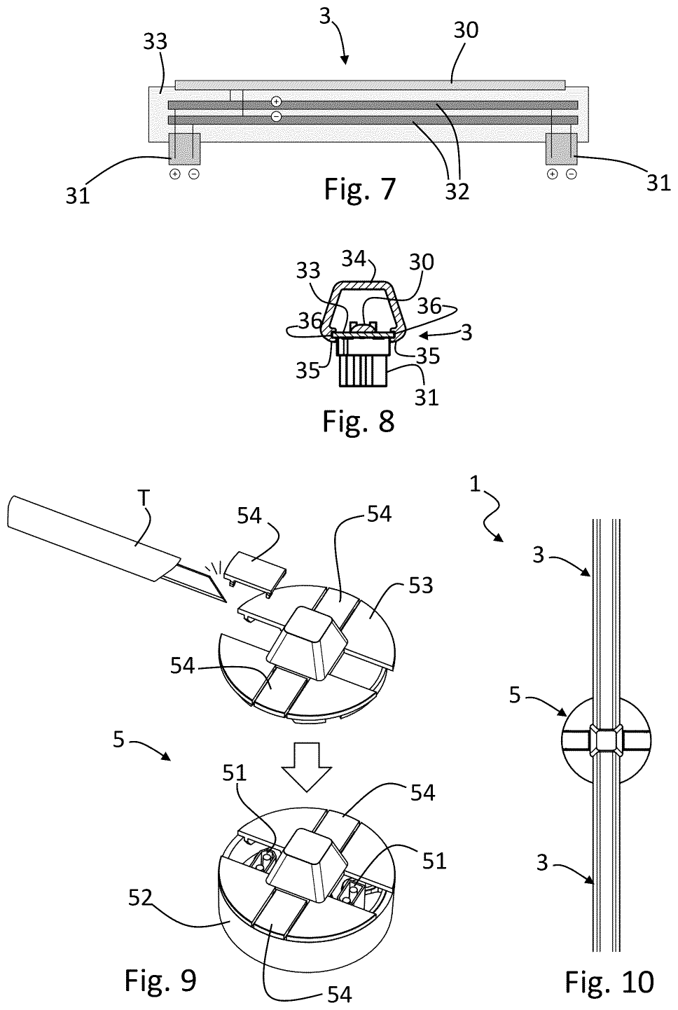

In particular, as shown in FIGS. 6 and 7, the diffuser 34 and printed circuit 33 both have a main longitudinal development direction. The diffuser 34 has an inverted U-shaped cross-section. The sliding and support guides 35 are preferably made at the two ends of the inverted U, and preferably develop along the entire length of the diffuser 34 itself.

The engagement of the diffuser 34 to the printed circuit 33 occurs by making the sliding and support guides 35 of the diffuser 34 slide along the side edges 36 of the printed circuit 33, along the entire length.

This makes the production assembly of the lighting module 3 very easy to perform and requires no additional fasteners.

Preferably the lighting source 30 comprises one or more LEDs, and/or an LED strip.

The printed circuit 33 supports the LEDs of the lighting source 30 and enables the power supply thereof by means of the conductive tracks 32.

Preferably, the diffuser 34 is made of a polymeric material (e.g. plastic) by means of extrusion techniques.

The lighting modules 3 of a modular lighting apparatus 1 of the same kind can also be of different lengths.

Preferably the connection base 5 comprises a housing body 52 inside which at least the aforesaid second connectors 51 are housed. This housing body 52 is open at one end. The connection base 5 further comprises a removable lid 53 adapted to close the opening of the housing body 52. The lid 53 comprises a plurality of removable caps 54 placed at the second connectors 51 present in the housing body 52.

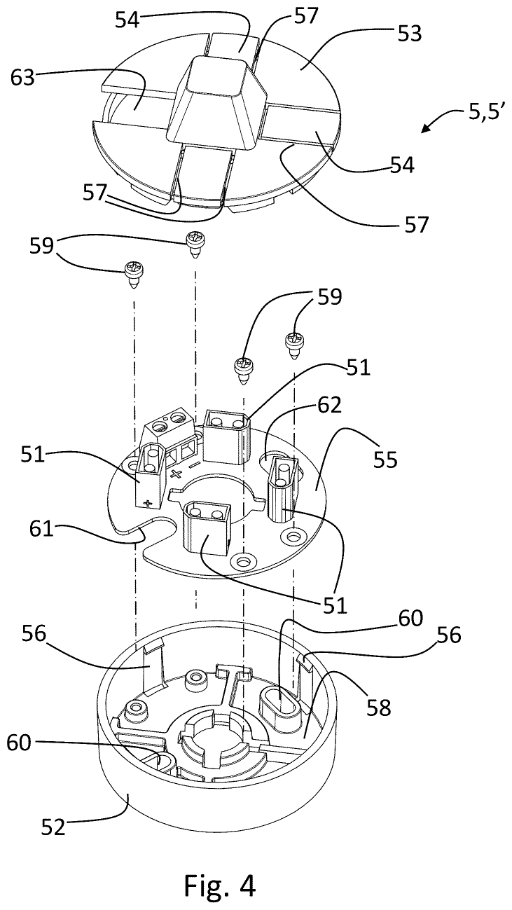

As shown for example in FIG. 4, since each connection base 5 is connected to at least one lighting module 3, the lid 53 has at least one access opening 63 at one of the second underlying connectors 51. If there is a need to expose further second connectors 51 for the connection of further lighting modules 3, one or more removable caps 54 can be removed if necessary.

Preferably, the removable caps 54 are associated with the lid 53 by means of pre-cut lines 57, or weakening lines, which make removal thereof easier, for example by using a common T-cutter, as shown in FIG. 9.

The second connectors 51 of the connection base 5 that are not connected to a respective lighting module 3 thus remain covered for safety, as well as aesthetic reasons.

Preferably also the connection base 5 comprises a printed circuit 55 (PCB) to which the second connectors 51 and the inner terminal 50 are associated.

As shown in FIG. 4, the housing body 52 comprises at least one elastic engagement tab 56 adapted to fix the lid 53 to the container body 52. Preferably, the housing body 52 comprises a plurality of such elastic engagement tabs 56. Such an elastic engagement tab 56 preferably configures a snap engagement of the lid 53 to the housing body 52.

Preferably, the printed circuit 55 which bears the second connectors 51 and the inner terminal 50 is adapted to be fixed to the base 58 of the housing body 52 by means of a plurality of fastening screws 59.

Preferably, at least one through-hole 60 configured to allow the connection of the inner terminal 50 to the power supply network by means of electric cables is formed into the base 58 of the housing body.

Preferably, the printed circuit 55 also comprises recesses 61 or through-holes 62 formed at the aforesaid through-holes 60 of the base 58.

As shown in the accompanying figures, the connection base 5, 5′ has a circle-shaped plan projection and is provided with four second connectors 51.

Preferably the first connectors 31 and the second connectors 51 have a male and female configuration respectively and are mutually connectable by pressure. Connectors 31 and 51 are preferably of the pin type. Thus, the lighting modules 3 connect to the connection bases 5 along a perpendicular direction, in a very straightforward manner.

Preferably, the connection bases 5 are configured to be fixed to a wall, or to be fixed to a ceiling, or to be suspended from a ceiling by means of a steel cable.

The “+” and “−” symbols in the enclosed figures indicate whether the connector pin, or the power line, or even the conductive track, have a positive or negative polarity.

The functioning of the modular lighting apparatus 1 is clear and evident from what described.

In particular, a main connection base 5′ is power supplied from the power supply network by means of the inner power supply terminal 50. The lighting modules 3 connected to that main connection base 5′ receive their power supply from that base, and transmit it to all the further connection bases 5 to which they are connected, and from there to any further lighting modules 3.

In fact, whether a connection base 5, 5′ receives its power supply by means of the inner terminal 50, or receives its power supply by means of a second connector 51, all the other second connectors 51 present in the connection base 5 will also be electrically supplied, in parallel with each other, and will allow the switching on of the lighting modules 3 that will be connected to them.

In particular, when the lighting source 3 comprises LEDs, a driver 58 connected to the inner terminal 50 of the main connection base 5′ is also provided.

Due to the presence of the conductive tracks 32 the lighting module 3 also functions as a conductor of electricity.

Thus, the modular lighting apparatus 1 is capable of functioning whatever configuration the user intends to give to the modular lighting apparatus, 1, by variously combining various lighting modules 3, also of different lengths, and various connection bases 5.

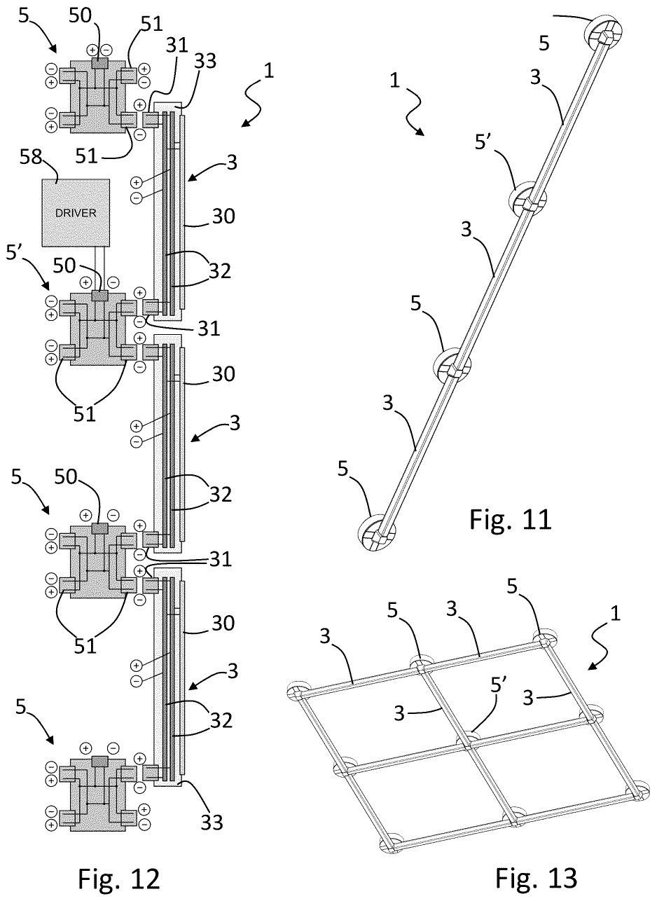

FIGS. 11 and 13 show two different possible configurations of the modular lighting apparatus according to the invention. In the linear configuration of FIG. 11, the lighting modules 3 are connected in line by means of connection bases 5, one of which serves as the main connection base 5. In the grid configuration of FIG. 12, the lighting modules 3 are connected to each other by means of the grid-shaped connection bases 5. Even in this case, one of the connection bases 5′ serves as the main connection base 5′ connected to the power supply network. The power supply is then distributed to all the lighting modules 3, and in particular also to those not directly connected to the main connection base 5′.

In practice, it was proven that a modular lighting apparatus according to the present invention fulfils the task as well as the intended purposes, as it allows light compositions to be created as desired, in a very simple way.

Another advantage of a modular lighting apparatus according to the invention is that no electrical components or electrical cables are required to connect the various lighting modules.

An additional advantage of a modular lighting apparatus according to the invention is that the assembly of the lighting modules to the connection bases is very simple and requires in practice only the removal of the removable caps that need to be removed, and the connection of the electrical connectors.

The modular lighting apparatus thus conceived is susceptible to several modifications and variations, all falling within the scope of the inventive concept.

Furthermore, all the details can be replaced by other technically equivalent elements.

In practice, any materials can be used according to requirements, as long as those materials are compatible with the specific use, dimensions, and contingent shapes.

The invention claimed is:

1. A modular lighting apparatus comprising:
a plurality of lighting modules; and
a plurality of connection bases, each of said lighting modules having a shape elongated along a main longitudinal development direction, each of said lighting modules being configured to be connected, at opposite longitudinal ends thereof, to a pair of said connection bases, each of said connection bases being configured to be connected to a plurality of said lighting modules,
each lighting module comprising:
one or more lighting sources;
a pair of first connectors arranged at the longitudinal ends of said lighting module; and
a pair of electrically conductive tracks configured to transmit electric current between said pair of first connectors and to said one or more lighting sources, each connection base comprising a plurality of second connectors electrically connected to
each other in parallel, each of said second connectors being configured to be connected to a first connector of a lighting module,
wherein a main connection base of said plurality of connection bases comprises a power supply terminal electrically connected in parallel to said second connectors, and configured to be electrically connected to an electrical power supply network.

2. The modular lighting apparatus according to claim 1, wherein said lighting module comprises a printed circuit, on which said electrically conductive tracks are defined and to which said first connectors are associated.

3. The modular lighting apparatus according to claim 2, wherein said lighting module comprises a diffuser coupled to said printed circuit by a pair of sliding and support guides configured to slide alongside edges of said printed circuit and to support said diffuser on said printed circuit.

4. The modular lighting apparatus according to claim 1, wherein said one or more lighting sources comprise LEDs.

5. The modular lighting apparatus according to claim 4, further comprising a driver connected to said power supply terminal of said main connection base.

6. The modular lighting apparatus according to claim 1, wherein said connection base comprises a housing body, inside which at least said second connectors are housed, and a removable lid, configured to close said housing body, said removable lid comprising a plurality of removable caps located at said plurality of second connectors.

7. The modular lighting apparatus according to claim 1, wherein said first connectors and said second connectors respectively have a male and a female configuration and are mutually connectable by pressure.

8. The modular lighting apparatus according to claim 1, wherein said connecting bases are configured to be fixed to a wall, or to be fixed to a ceiling, or to be suspended from a ceiling with a steel cable.

9. The modular lighting apparatus according to claim 1, wherein any of said connection bases performs a function of said main connection base when electrically connected to said power supply network.

10. The modular lighting apparatus according to claim 1, wherein said lighting module operates as an electric current conductor due to said electrically conductive tracks.
